(19) United States
(12) Patent Application Publication
(10) Pub. No.: US 2007/0162512 A1
(43) Pub. Date: Jul. 12, 2007

(54) Providing reporting database functionality using copy-on-write technology

(75) Inventors: Lubor J. Kollar, Redmond, WA (US); Michael L. Ruthruff, Bellevue, WA (US); Stuart Ozer, Moraga, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/439,398

(22) Filed: May 22, 2006

Related U.S. Application Data
(60) Provisional application No. 60/757,759, filed on Jan. 10, 2006.

(51) Int. Cl. G06F 17/30

(52) U.S. Cl. 707/200

(57) ABSTRACT

In order to provide a reporting (read-only) copy of an original database, copy-on-write technology is used to quickly create a shadow copy which contains pointers to the data in the original database. When no changes are allowed to the shadow copy, the copy-on-write technology functions to create a static snapshot of the original database at the point in time that the reporting copy was created. The overhead in providing a reporting copy is thus reduced, as no wholesale copying of the original database is required, and updates can be performed quickly. Because the reporting copy is read-only, multiple reporting servers can use the same copy-on-write maintained copy of the original database.

### CROSS-REFERENCE TO RELATED APPLICATION

This application claims priority to U.S. Provisional Application No. 60/757,759, filed on Jan. 10, 2006 and entitled “Providing Reporting Database Functionality Using Copy-On-Write Technology,” the contents of which are hereby incorporated by reference in their entirety.

### BACKGROUND OF THE INVENTION

A scalable-shared database may be used in situations where users require only read-access to data in a production database. A scalable-shared database reduces a workload of the production database by providing a read-only copy, known as a reporting database, of the production database to at least one database server instance. The reporting database resides on a reporting volume and may be accessed by multiple servers. Thus, a scalable-shared database efficiently and cost-effectively provides access to the production database without negatively affecting the performance of the production database.

Unfortunately, numerous problems exist in the creation of the reporting database. The reporting database is traditionally created by copying the production database or be performing a back-up and restore operation. These methods are, however, inefficient, as a large amount of disk space is required for such operations, and time-consuming.

Thus, a system and method to efficiently and quickly create a reporting database of a production database is desired.

### SUMMARY OF THE INVENTION

Copy-on-write technology may be used to create a reporting database from a production database. Copy-on-write copies of data include pointers to the original data, known as a shadow copy of the data. When data is accessed from the copy-on-write copy, the pointer is followed in order to obtain the data. From the time the shadow copy is created, a private copy is created and includes a private copy of original data if the original data has been changed in the original copy.

When changes to the production database occur, the reporting database may not necessarily be updated. A differences area is part of the reporting database and stores original data that is about to be changed in the production database, preserving a copy of the original data before it is modified and overwritten. Thus, the reporting database presents all data in the production database at the point in time in which the reporting database was created.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing summary and the following detailed description are better understood when read in conjunction with the appended drawings. Exemplary embodiments are shown in the drawings, however it is understood that the embodiments are not limited to the specific methods and instrumentalities depicted therein. In the drawings:

FIG. 1 is a block diagram representing an exemplary computing device in which the present invention may be implemented;

FIG. 2 is a block diagram of a system including a reporting database; and

FIG. 3 is a flow diagram of a method for implementing a reporting database.

### DETAILED DESCRIPTION OF ILLUSTRATIVE EMBODIMENTS

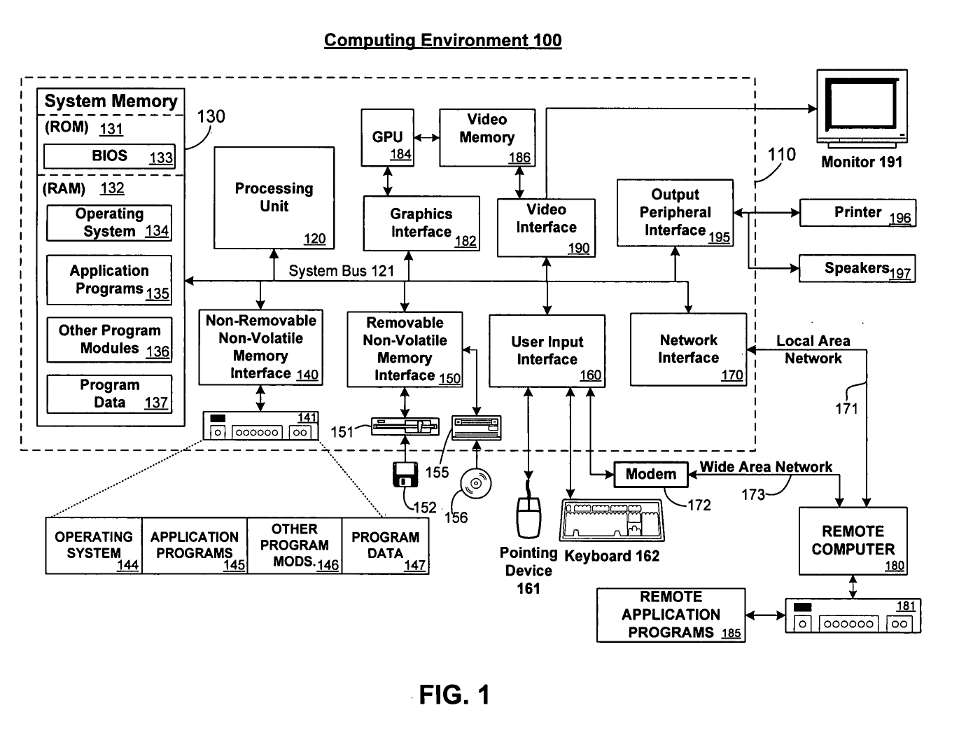

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary computing environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Certain users of a database may require the capability to modify data stored in the database or to add additional data to the data in the database. Thus, for example, where the database is a relational database which stores records containing database data, such a user may need to modify a record or may need to add additional records to the database. As a further example, a database which stores records of business transactions may need to be added to as new transactions occur, and an existing transaction may need to be modified, for example when additional information regarding the transaction is gathered.

However, certain users do not require access to change or add to data in the database. For example, the creation of a report regarding data in the database need only read access to the database and not read/write access. Thus, as an example, a user wishing only to query the database or to use a reporting service to create meta-data about the data in the database does not need to be able to modify or add records to the database.

When a production database is used by multiple users, the workload on that database increases. This means a possible decrease in database performance may result or that additional resources (processing and/or memory) may be required for the database. Because, as noted, some uses of a database require only read-access, scalable shared databases may be used to decrease the workload of the database.

A scalable shared database system provides a read-only copy of the production database to at least one (and possibly more than one) database server instance. This read-only copy, termed a reporting database, can then be used to provide access for any multiple purposes for which read-only access is sufficient and read/write access is not required.

In order to provide this read-only access, a reporting database resides on one or more dedicated read-only storage mechanisms, such as disk volumes. These storage mechanisms are known as reporting volumes.

By using scalable shared databases, workload for a database can be shifted to a reporting database. Because a reporting database can be accessed by more than one database server, scalable shared databases thus can be scaled up to provide access to the database to more users without the performance degradation which might otherwise arise. Thus, the scalable shared database is a cost-effective way of making read-only data marts or data warehouses available to multiple server instances for reporting purposes, such as running queries or using reporting services.

In order to use a scalable shared database as a reporting database, a three phase update cycle is used. First, in a build phase, before a reporting database can be built, the reporting storage is operably connected to the production system. The administrator then builds the reporting database on the reporting storage (e.g. a reporting volume) by copying the data from the production database to the reporting storage. This requires that reporting storage be in writable mode. Copying a production database to a reporting volume may be performed, for example, by data-copy methods provided by the database program.

The attach phase comes after the build phase. The attach phase makes the reporting database available as a scalable shared database. To configure the reporting database as a scalable shared database, the reporting storage is connected to the reporting server. For example, where a storage area network (SAN) is used, and reporting volumes hold the reporting database, an administrator mounts the read-only reporting volumes onto a reporting server over the SAN. After the administrator makes sure that each volume is set to read-only, the administrator attaches the reporting database on an instance of the database server (the reporting server). Because each reporting volume is read-only, attaching the database sets the reporting database to read-only. At this point, the reporting database becomes a scalable shared database that can be accessed by clients by using the reporting server.

The third phase is the detach phase. Typically, because data in the database is being added to and modified in the production database, the production database diverges from the reporting database, and the reporting database eventually becomes stale. The reporting database must be refreshed to keep the reporting data current. The detach phase is the process of removing a stale reporting database from service as a scalable shared database. When a reporting database must be refreshed, the reporting database must be detached from all the server instances. To start the detach phase, first, the query work load that is coming in to the database from all the server instances is stopped. On each server instance, exclusive access to the reporting database is obtained, and then the reporting database is detached. The reporting storage is then dismounted. An updated reporting storage is then mounted.

To maximize the availability of reporting data, two or more storage mechanisms may be alternated between. When the first reporting volume is still mounted to the reporting servers, the up-to-date version of the production database is built on the second reporting volume. The first reporting volume can then be dismounted and the second mounted. When a switch is needed this process repeats.

In subsequent update cycles, the reporting database on reporting storage can be either updated or rebuilt. If the reporting database is a data mart database (an extract from the production database) a new version may be created for each cycle. However, if the reporting database is an exact copy of the production database, the reporting database can be periodically updated. One possible way to periodically update the database is to create a full backup of the production database and then restore the database backup on the reporting volume or volumes.

Depending on situational requirements, a rolling upgrade can occur in a limited timeframe, or the rolling upgrade can be relatively open-ended to allow current transactions to finish. If transactions are allowed to finish, in performing a rolling upgrade, long-running transactions are allowed to finish on one reporting server when the database on another reporting server is refreshed. This strategy is operable where reporting servers do not have to be kept in sync and permits a rolling upgrade between the stale reporting database and the updated reporting database. This is also operable where an unlimited timeframe is available to accomplish the update or where the deadline is less critical than preserving currently running transactions.

However, if a limited timeframe is available for updates, and the deadline is more critical than preserving currently running transaction, then transactions may be interrupted. One way to accomplish this is to first stop incoming I/O activity to the reporting volume, and, optionally, wait for short transactions to finish on a server instance before detaching its reporting database. That server is detached from the reporting database. An updated reporting database is then attached. This strategy guarantees that the overall reporting capability is never interrupted. This strategy tolerates fairly long-running transactions on some of the server instance; however, given the limited timeframe for updating all the reporting databases, if a long-running query significantly delays the upgrade on a server instance, that query is stopped. The query can wait to be rerun on the same server instance after its reporting database has been refreshed, or the query can be restarted sooner on an updated server.

In the shared scalable database scheme described above, the reporting copy of the database is created by either copying the production database or by performing a backup and restore operation. However, this requires disk space for the reporting which is the same or very similar to the disk space of the original (production) database. Additionally, creating the reporting copy of the database takes time, and it may be desirable to shorten the time required.

Thus, in order to provide for rapid creation of reporting databases, a reporting database is created as a copy-on-write copy of the database. This can be done by any means used for implementing copy-on-write. For example, the reporting volumes storing the reporting database may be set to be copy-on-write volumes. Copy-on-write can also be implemented in other ways, e.g. via purely hardware solutions, software solutions, or solutions including a combination of hardware and software.

Copy-on-write copies of data optimize storage by including pointers to original data (as a “shadow copy” of the data) rather than providing a copy of the original data itself. Generally, when information is accessed for reading from a copy-on-write volume, the information is provided by following the pointer to obtain the requested information. Additionally, in order to prevent confusion between versions of data for a user of a shadow copy of the data, when the original data changes, a copy of the original data is stored as a private copy. Thus, copy-on-write provides a private copy of any data which has been changed since the time the shadow copy was created: a private copy of the original page if the original page has been changed in the original copy.

The copy-on-write facility may be used in order to provide an unchanging “snapshot” of the original data at a given point in time with low overhead. In order to provide this, even though the production database, as described above, may be a read/write database, the shadow copies made using the copy-on-write are set as read-only.

Thus, by using copy-on-write, the data from the production database is accessed with low overhead. Many servers can be connected to a large database using a single physical copy of the dataset without the need to maintain multiple physical copies of the data. The copy-on-write functionality of the reporting copy of the database acts as a way to provide access to the production database data without requiring an actual copy of the database. In other words, the reporting copy can be made “read only” without affecting the ability to update the original database because some implementations of the copy-on-write functionality will mask any changes. This enables users to create reports and perform other tasks on the copy of the data without affecting the work of the server hosting the original database and without the long delays and large disk space otherwise required to create complete copy of the production database.

The reporting copy obtained using the copy-on-write volume does not change with changes to the production copy. Thus, updating as described above may still occur. When a change to the production volume occurs, the block about to be modified is read and then written to a “differences area” for the reporting copy. This preserves a copy of the data block before the data is overwritten with the change. The pointer in the reporting copy is changed to point to the original copy in the differences area. Because the reporting copy includes the blocks in the differences area and unchanged blocks in the original (production) volume, the reporting copy is a logical copy containing all the data in the production copy at the point in time the reporting copy was created. This copy-on-write is almost instantaneous and the consumed space is a fraction of the production database's disk space. Additionally, updates can also occur almost instantaneously.

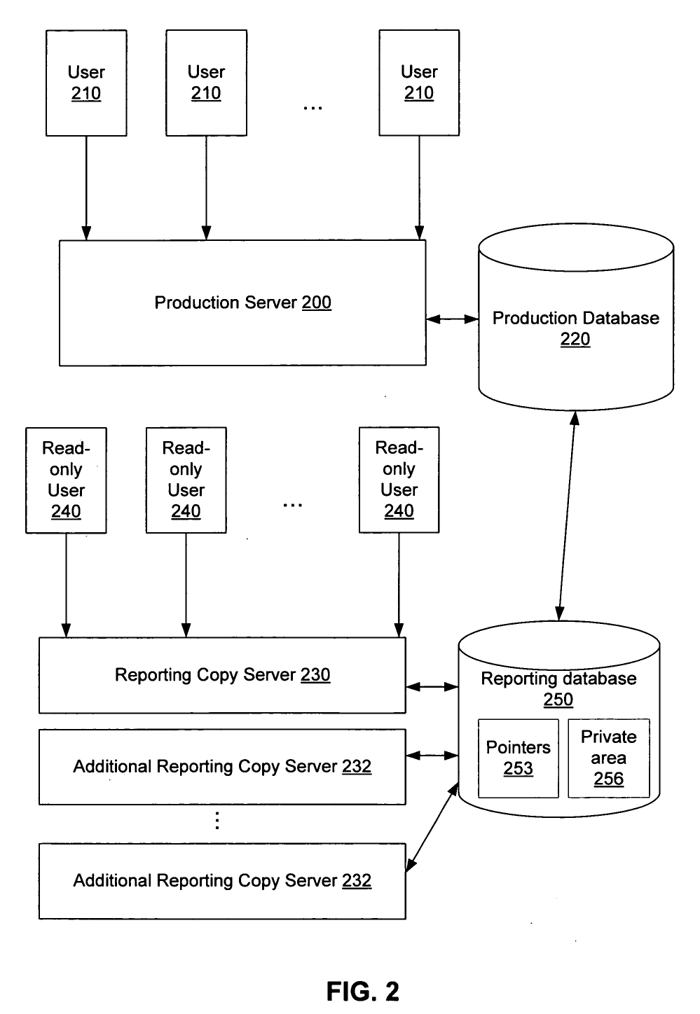

FIG. 2 is a block diagram of a system including a reporting database. As shown in FIG. 2, a production server 200 serves users 210 with production data from production database 220. A reporting copy server 230 serves users 240 with reporting data from reporting database 250. Reporting database 250 includes pointers 253 which provide a copy of the data in production database 220 as the data that existed at the point in time that reporting database 250 was created or last updated. Some of these pointers 253 point to data from the reporting database 250, when the data has not been changed. Other pointers 253 point to data in the private area 256 of reporting database 250. This private area 256 stores copies of data from the production database 220 which have been changed since the reporting database 250 was first created or re-synchronized with the production database 220.

When a change is made to data in production database 220, the pre-change version of the data is stored in private area 256 and the corresponding pointer 253 is changed to point to that pre-change version. Only then is the data changed in the production database. Thus, users 240 can always access the version of the data from the production database 220 which existed at last creation or change of the reporting database 250. As shown in FIG. 2, additional reporting copy servers 232 may also use reporting database 250, and these may provide additional users (not shown) with access to reporting database 250.

While data is described as being changed, stored, and copied, as will be understood by one of ordinary skill in the art, blocks of data, pages of data, or other units of data are generally used in order to provide atomic operations with respect to data.

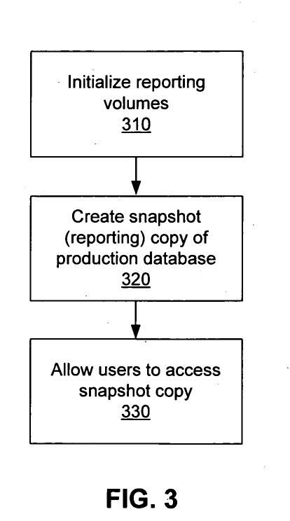

The high-level process for implementing a reporting database such as reporting database 250 is shown in the flow diagram of FIG. 3. FIG. 3 is a flow diagram of a method for implementing a reporting database 250. At 310, reporting volumes are created for the production database 220. At 320, a point-in-time snapshot copy of the production volume(s) is created. In order to accomplish this, the production database may need to be momentarily quiesced and all outstanding I/O may need to be flushed. Alternately, other approaches (such as Volume Shadow Copy (VSS) Service in Microsoft Corporation's SQL Server product) may be used to otherwise manage the I/O and create a snapshot backup. At 330, the point-in-time snapshot copy is presented to read-only users for use. Using the scalable shared database technology, the same read-only reporting database may be used by multiple reporting servers similar to the reporting copy server 230, as shown in FIG. 2.

As can be appreciated, the disclosed embodiments may be implemented as a whole or in part in one or more computing systems or devices. FIG. 1 illustrates the functional components of one example of a computing system 100 in which aspects may be embodied or practiced. As used herein, the terms “computing system,” “computer system,” and “computer” refer to any machine, system or device that comprises a processor capable of executing or otherwise processing program code and/or data. Examples of computing systems include, without any intended limitation, personal computers (PCs), minicomputers, mainframe computers, thin clients, network PCs, servers, workstations, laptop computers, hand-held computers, programmable consumer electronics, multimedia consoles, game consoles, satellite receivers, set-top boxes, automated teller machines, arcade games, mobile telephones, personal digital assistants (PDAs) and any other processor-based system or machine. The terms “program code” and “code” refer to any set of instructions that are executed or otherwise processed by a processor. Program code and/or data can be implemented in the form of routines, programs, objects, modules, data structures and the like that perform particular functions.

It is noted that the foregoing examples have been provided for the purpose of explanation and are in no way to be construed as limiting. While the invention has been described with reference to various embodiments, it is understood that the words which have been used herein are words of description and illustration, rather than words of limitation. Although the embodiments have primarily been described with reference to multiple virtual machines, the embodiments are not intended to be limited to multiple virtual machines and in fact one virtual machine may be used without departing from the spirit and scope of the present invention. Further, although the embodiments have been described herein with reference to particular means, materials, and examples, the embodiments are not intended to be limited to the particulars disclosed herein; rather, the embodiments extend to all functionally equivalent structures, methods and uses, such as are within the scope of the appended claims.

What is claimed:

1. A method of implementing a reporting database of a production database, the method comprising:
creating a reporting volume of the production database;
creating a snapshot of a production volume of the production database; and
providing the snapshot to a read-only user through a reporting copy server instance.

2. The method of claim 1, wherein creating a reporting volume of a production database comprises:
connecting a reporting storage to the production database;
making data from the production database available to the reporting storage; and
connecting the reporting storage to a reporting server.

3. The method of claim 2, wherein making data from the production database available to the reporting storage comprises employing a data-copy method of a database program.

4. The method of claim 2, wherein making data from the production database available to the reporting storage comprises employing copy-on-write technology.

5. The method of claim 1, wherein the reporting database is a scalable shared database system.

6. The method of claim 1, further comprising refreshing the reporting database.

7. The method of claim 6, wherein refreshing the reporting database comprises:
stopping work requests to the reporting database from the reporting copy server instance;
detaching the reporting database;
dismounting a reporting storage; and
mounting an updated reporting database.

8. A reporting database for providing a read-only copy of a production database to at least one database server instance, the reporting database comprising:
an unchanged data area storing unchanged data from the production database;
a private data area storing changed data from the production database;
unchanged data pointers pointing to the unchanged data; and
changed data pointers pointing to the changed data.

9. The reporting database of claim 8, wherein the changed data stored in the private data area comprises data that is about to be changed in the production database.

10. The reporting database of claim 8, wherein the reporting database is detached from the at least one database server instance to refresh the data in the reporting database.

11. The reporting database of claim 8, wherein the data in the reporting database is read-only data.

12. The reporting database of claim 8, wherein the reporting database is a scalable shared database system.

13. The reporting database of claim 8, wherein the reporting database is a copy-on-write copy of the production database.

14. A computer-readable medium having program code stored therein for use in a system comprising a production database for providing a reporting database to at least one database server instance, the program code, when executed, causing the system to perform the following:
creating a reporting volume of the production database;
creating a snapshot of a production volume of the production database; and
providing the snapshot to a read-only user through a reporting copy server instance.

15. The computer-readable medium of claim 14, wherein creating a reporting volume of a production database comprises:
connecting a reporting storage to the production database;
making data from the production database available to the reporting storage; and
connecting the reporting storage to a reporting server.

16. The computer-readable medium of claim 15, wherein making data from the production database available to the reporting storage comprises employing a data-copy method of a database program.

17. The computer-readable medium of claim 15, wherein making data from the production database available to the reporting storage comprises employing copy-on-write technology.

18. The computer-readable medium of claim 14, wherein the reporting database is a scalable shared database system.

19. The computer-readable medium of claim 14, further comprising program code, when executed, causing the system to refresh the reporting database.

20. The computer-readable medium of claim 19, wherein causing the system to refresh the reporting database comprises:
stopping work requests to the reporting database from the reporting copy server instance;
detaching the reporting database;
dismounting a reporting storage; and
mounting an updated reporting database.
